(19) United States
(12) Patent Application Publication
(10) Pub. No.: US 2019/0210832 A1
(43) Pub. Date: Jul. 11, 2019

(54) ELEVATOR SYSTEM AND METHOD OF POSITIONING AN ELEVATOR CAR WITH HIGH ACCURACY

(71) Applicant: Otis Elevator Company, Farmington, CT (US)

(72) Inventor: Mustapha Toutaoui, Berlin (DE)

(21) Appl. No.: 16/240,128

(22) Filed: Jan. 4, 2019

(30) Foreign Application Priority Data
Jan. 11, 2018 (EP) 18151281.5

(51) Int. Cl. B66B 1/34; B66B 1/40; B66B 5/00; B66B 1/28

(52) U.S. Cl. CPC B66B 1/3492; B66B 1/28; B66B 5/0031; B66B 1/40

(57) ABSTRACT

An elevator system (2) comprises a hoistway (4) extending in a longitudinal direction between a plurality of landings (8); an elevator car (6), which is configured for traveling along the hoistway (4) between the plurality of landings (8); at least one three-dimensional structure (12) extending along at least a section of the hoistway (4) in a longitudinal direction; and an optical sensor (25) attached to the elevator car (6). The optical sensor (25) is configured for detecting the at least one three-dimensional structure (12) in order to determine the current position of the elevator car (6) within the hoistway (4).

The invention relates to an elevator system and to a method of positioning an elevator car in an elevator system.

An elevator system comprises at least one elevator car traveling along a hoistway between a plurality of landings. In order to allow for a safe operation of the elevator system, it is necessary to reliably determine the current position of the elevator car within the hoistway. For example, determining the current position of the elevator car within the hoistway with good accuracy is necessary for positioning the elevator car at the landings without a noticeable step between the respective landing and the floor of the elevator car. Such a step would constitute a trap hazard for passengers entering and leaving the elevator car.

It therefore is desirable to provide an elevator system and a method of positioning an elevator car in an elevator system which allow reliably determining the current position of the elevator car within the hoistway with good accuracy.

According to an exemplary embodiment of the invention, an elevator system comprises a hoistway extending in a longitudinal direction between a plurality of landings; an elevator car, which is configured for traveling along the hoistway between the plurality of landings; at least one three-dimensional structure extending in the longitudinal direction along at least a section of the hoistway; and an optical sensor attached to the elevator car and configured for detecting the at least one three-dimensional structure and determining the current position of the elevator car within the hoistway from the at least one detected three-dimensional structure.

Exemplary embodiments of the invention also include a method of determining the position of an elevator car in the hoistway of an elevator system according to an exemplary embodiment of the invention, wherein the method includes moving the elevator car along the hoistway, detecting the at least one three-dimensional structure and determining the current position of the elevator car within the hoistway from the at least one detected three-dimensional structure.

Detecting a three-dimensional structure extending along at least a section of the hoistway with an optical sensor allows reliably determining the current position of the elevator car with good accuracy. Three-dimensional structures may be reliably detected with good accuracy even if polluted by dust or dirt. Three-dimensional structures having small dimensions allow determining the current position of the elevator car with a high resolution.

A number of optional features are set out in the following. These features may be realized in particular embodiments, alone or in combination with any of the other features.

The at least one three-dimensional structure may be periodic in the longitudinal direction and comprise a plurality of periodic three-dimensional features such as edges. In such a configuration the sensor may be configured for detecting and counting the periodic three-dimensional features of the at least one three-dimensional structure passed by the elevator car when moving along the hoistway. Counting three-dimensional features of a periodic three-dimensional structure allows for a reliable and easy determination of the position of the elevator car within the hoistway.

The at least one three-dimensional structure may comprise a plurality of sub-structures, in particular sub-structures having triangular cross-sections. Triangular cross-sections include edges which may be detected easily and reliably by an optical sensor.

The optical sensor may be mounted on top, at the bottom or at a side of the elevator car depending on which position is most convenient in the respective configuration. An elevator system according to embodiments of the invention therefore allows for a plurality of design options.

The three-dimensional structure may extend over the whole length (height) of the hoistway. Such a configuration allows determining the current position of the elevator car with good accuracy over the whole length of the hoistway using the optical sensor mounted to the elevator car.

Alternatively, the three-dimensional structure may extend only over selected sections of the length of the hoistway. The three-dimensional structure in particular may extend only over sections of the hoistway adjacent to the landings. Such a configuration allows positioning the elevator car with good accuracy at the landings. It further saves the costs for providing the three-dimensional structure along the whole length of the hoistway. In the sections of the hoistway between the landing portions, it is sufficient to determine the position of the elevator car with less accuracy. Thus, these sections need not be provided with three-dimensional structures. In the sections between the landing areas, the position of the elevator car may be determined using alternative sensors such as speed sensors and/or acceleration sensors, which do not need a three-dimensional structure within the hoistway.

The three-dimensional structure in particular may include a plurality of three-dimensional structures, each three-dimensional structure extending over a section of the height of the hoistway, in particular over a section of the hoistway adjacent to one of the landings. Such a configuration allows providing the three-dimensional structures, which are necessary for determining the position of the elevator car with the optical sensor, in the sections of the hoistway adjacent to the landings in order to allow positioning the elevator car with good accuracy at the landings.

The at least one three-dimensional structure may be provided by at least one marking element mounted to a wall of the hoistway. The at least one three-dimensional structure in particular may be provided by at least one marking element mounted to at least one door frame of a landing door (landing door frame) at one of the landings.

Mounting marking elements, which may be pre-manufactured, provides a convenient way of forming the three-dimensional structure(s) within the hoistway. The mounting elements in particular may be mounted to the door frames of the landing doors in the factory in order to facilitate the installation of the elevator system and/or to ensure a good accuracy when positioning the marking elements with respect to the landing doors.

The optical sensor may be configured for emitting and detecting visual light, IR and/or UV light as it is appropriate under the respective circumstances. The optical sensor in particular may comprise a laser light source which is configured for emitting a focused (laser) light beam. A focused light beam allows for a reliable detection of the three-dimensional structure, in particular of a three-dimensional structure including periodic three-dimensional features having small dimensions.

A method of operating an elevator system according to an embodiment of the invention may include reducing the speed of the elevator car when the determined position of the elevator car is within a predetermined first distance from a predetermined destination landing, and stopping the elevator car when the determined position of the elevator car is within a predetermined second distance from the predetermined destination landing, with the predetermined second distance being smaller than the predetermined first distance. This allows positioning the elevator car at the predetermined destination landing with good accuracy forming only a small step or even no step at all between the landing and the floor of the elevator car.

Operating an elevator system according to an embodiment of the invention may include leveling the elevator car at one of the landings. Leveling includes stopping the elevator car at the landing, determining any movement of the elevator car by detecting the at least one three-dimensional structure, and changing the position of the elevator car by controlling a drive unit of the elevator system in case the difference between the determined position of the elevator car and a predetermined position associated with the landing exceeds a given threshold. Leveling the elevator car at a landing prevents creating or increasing a step formed between the landing and the floor of the elevator car.

In the following an exemplary embodiment of the invention is described with reference to the enclosed figures.

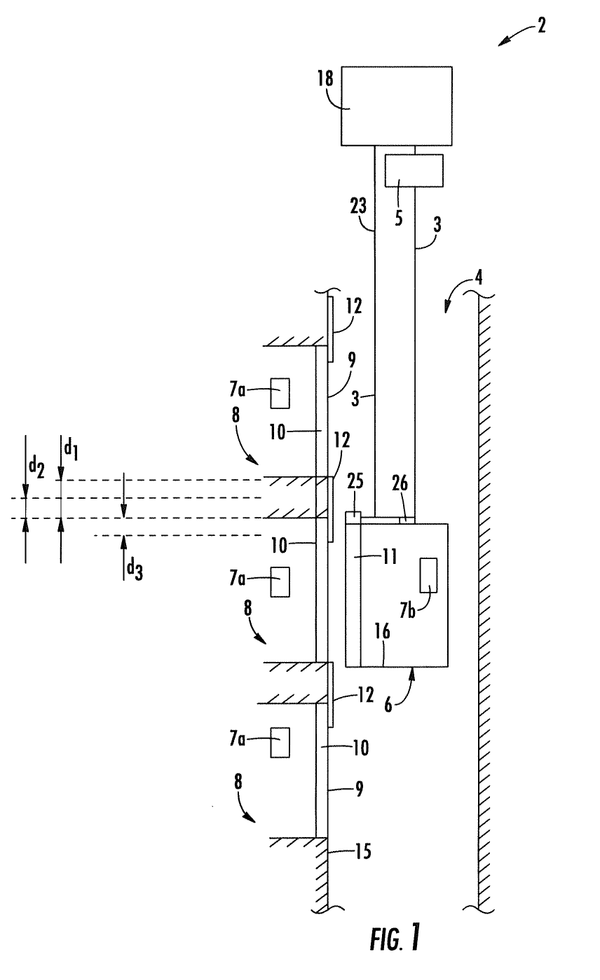

FIG. 1 schematically depicts an elevator system comprising an elevator safety system according to an exemplary embodiment of the invention.

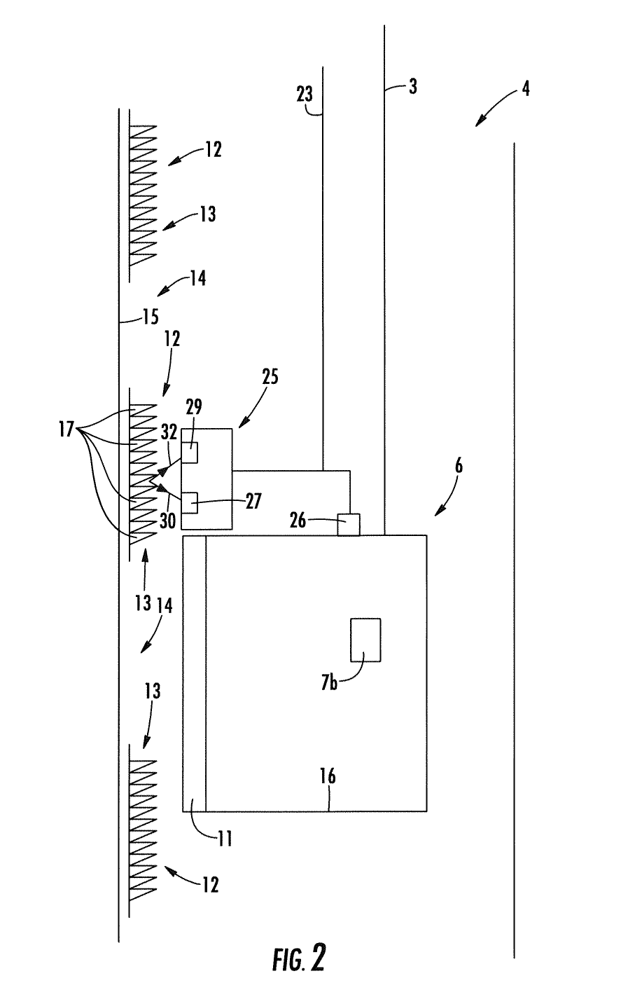

FIG. 2 shows a schematic enlarged view of a section of the hoistway and an elevator car.

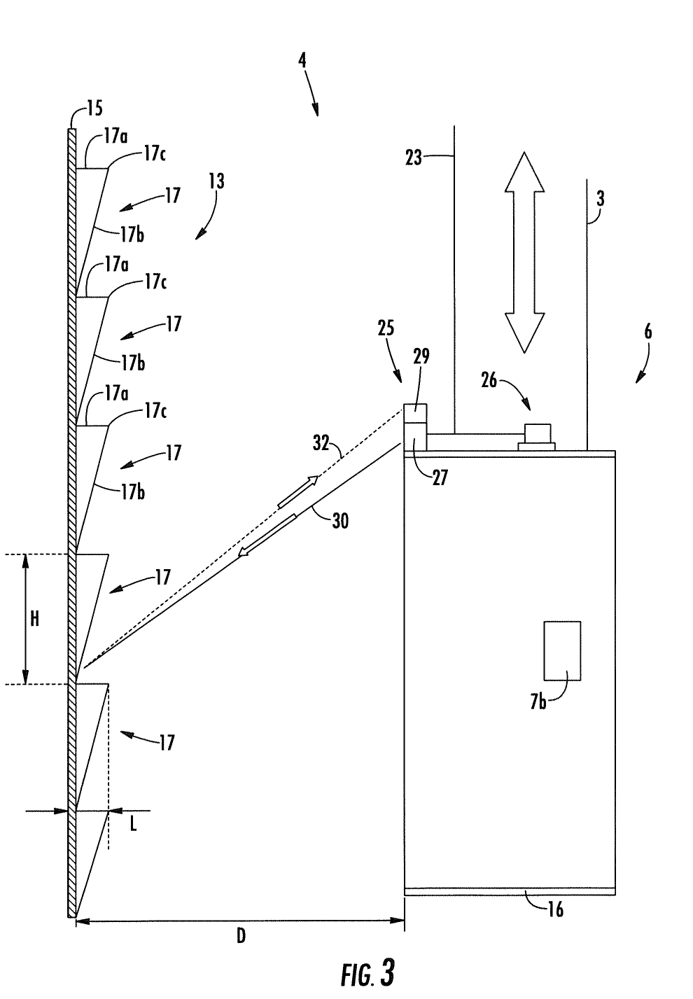

FIG. 3 shows an even further enlarged view of a section of the hoistway and an elevator car.

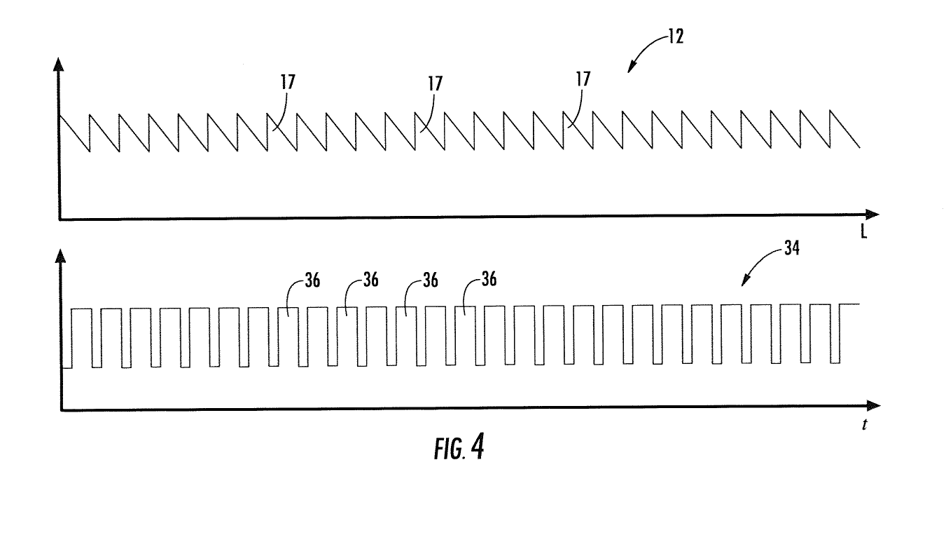

FIG. 4 illustrates the signal provided by the light sensor when the elevator car travels along the hoistway passing the three-dimensional structure.

FIG. 1 schematically depicts an elevator system 2 according to an exemplary embodiment of the invention.

The elevator system 2 comprises a hoistway 4 extending in a longitudinal direction between a plurality of landings 8 located on different floors.

The elevator car 6 is movably suspended within the hoistway 4 by means of a tension member 3. The tension member 3, for example a rope or belt, is connected to a drive unit 5, which is configured for driving the tension member 3 in order to move the elevator car 6 along the longitudinal direction/height of the hoistway 4 between the plurality of landings 8.

Each landing 8 is provided with a landing door (elevator hoistway door) 10, and the elevator car 6 is provided with a corresponding elevator car door 11 allowing passengers to transfer between a landing 8 and the interior of the elevator car 6 when the elevator car 6 is positioned at the respective landing 8.

The exemplary embodiment of the elevator system 2 shown in FIG. 1 employs a 1:1 roping for suspending the elevator car 6. The skilled person, however, easily understands that the type of the roping is not essential for the invention and that different kinds of roping, e.g. a 2:1 roping, may be used as well. The elevator system 2 may further include a counterweight (not shown) moving concurrently and in opposite direction with respect to the elevator car 6. Alternatively, the elevator system 2 may be an elevator system 2 without a counterweight, as it is shown in FIG. 1. The drive unit 5 may be any form of drive used in the art, e.g. a traction drive, a hydraulic drive or a linear drive. The elevator system 2 may have a machine room or may be a machine room-less elevator system. The elevator system 2 may use a tension member 3, as it is shown in FIG. 1, or it may be an elevator system without a tension member 3, comprising e.g. a hydraulic drive or a linear drive (not shown).

The drive unit 5 is controlled by an elevator control unit 18 for moving the elevator car 6 along the hoistway 4 between the different landings 8.

Input to the elevator control unit 18 may be provided via landing control panels 7a, which are provided on each landing 8 close to the elevator landing doors 10, and/or via a car operation panel 7b provided inside the elevator car 6.

The landing control panels 7a and the car operation panel 7b may be connected to the elevator control unit 18 by means of electrical lines, which are not shown in FIG. 1, in particular by an electric bus, e.g. a field bus such as a CAN bus, or by means of wireless data connections.

In order to determine the current position of the elevator car 6, the car 6 is provided with an optical sensor 25. The elevator car 6 further may be provided with a speed and/or acceleration sensor 26 configured for determining the speed and/or acceleration of the elevator car 6.

The sensors 25, 26 may be arranged at the top of the elevator car 6 as shown in FIG. 1. Alternatively, the sensors 25, 26 may be provided at a side of the elevator car 6 or at the bottom, e.g. below a floor 16, of the elevator car 6.

The sensors 25, 26 are connected with the elevator control unit 18 via a signal line 23 or via a wireless connection (not shown) configured for transmitting sensor signals to the elevator control unit 18. The signal line 23 may be part of a bus connecting landing control panels 7a and the car operation panel 7b with the elevator control unit 18 or of a separate bus system.

For determining the actual position of the elevator car 6 within the hoistway 4, the optical sensor 25 is configured for detecting at least one three-dimensional structure 12 provided at a wall 15 of the hoistway 4 (hoistway wall 15).

The at least one three-dimensional structure 12 may extend over the whole length (height) of the hoistway 4. Alternatively, the at least one three-dimensional structure 12 may extend only over sections of the length of the hoistway 4, as it is illustrated in FIG. 1. There also may be a first three-dimensional structure 12 extending over the whole length of the hoistway 4 and a second three-dimensional structure 12 extending only over sections of the length of the hoistway 4.

In a configuration as it is illustrated in FIG. 1, in which the at least one three-dimensional structure 12 does not extend over the whole length of the hoistway 4, the position of the elevator car 6 may be determined by integrating information provided by the speed and/or acceleration sensor 26 attached to the elevator car 6 when the elevator car 6 is traveling in a section of the hoistway 4 which is not provided with a three-dimensional structure 12. In the sections of the hoistway 4 provided with a three-dimensional structure 12, in particular in sections adjacent to the landings 8/landing doors 10, the position of the elevator car 6 may be determined with increased accuracy from the interaction of the optical sensor 25 with the at least one three-dimensional structure 12. This will be described in more detail below.

FIG. 2 schematically shows an enlarged view of a section of the hoistway 4 with an elevator car 6. FIG. 3 shows an even further enlarged view. The landing portions 8 and the landing doors 10 are not shown in FIGS. 2 and 3. In order to illustrate the three-dimensional structures 12 more clearly, FIGS. 2 and 3 are not true to scale, i.e. the three-dimensional structures 12 have been enlarged disproportionately with respect to the elevator car 6.

In FIGS. 2 and 3, the three-dimensional structures 12 are provided as a plurality of marking elements 13 attached to the hoistway wall 15. Each marking element 13 extends in the longitudinal direction over a section of the hoistway 4. Each marking element 13 for example may have a length of 250 mm in the longitudinal direction. There are also sections 14 of the hoistway wall 15 which are not provided with a three-dimensional structure 12.

The marking elements 13 in particular may be attached to the hoistway wall 15 adjacent to the landing doors 10 in order to allow positioning the elevator car 6 with good accuracy at the landings 8. The marking elements 13 in particular may be attached to door frames 9 of the landing doors 10 (see FIG. 1).

In the embodiment shown in FIGS. 2 and 3, the three-dimensional structures 12 are periodic three-dimensional structures 12 respectively comprising a plurality of sub-structures 17. In the embodiment shown in FIGS. 2 and 3, each of the sub-structures 17 has a triangular cross-section. Each of the sub-structures 17 has an edge 17c constituting a periodic three-dimensional feature 17c facing the elevator car 6.

In the embodiment shown in FIGS. 2 and 3, each of the triangular sub-structures 17 has an upper side 17a extending horizontally, i.e. orthogonally from the vertical hoistway wall 15, into the hoistway 4. Each of the triangular sub-structures 17 further comprises an inclined lower side 17b extending between the outer edge 17c of the upper side 17a and the hoistway wall 15.

The upper sides 17a may have a length L of 0.1 mm to 10 mm, in particular a length L of 1 mm to 5 mm, respectively, and each of the triangular sub-structures 17 may have height H of 1 mm to 20 mm, in particular a height H of 5 mm to 15 mm, more particularly a height H of 10 mm (see FIG. 3).

The skilled person will understand that the sub-structures 17 depicted in FIGS. 2 and 3 are only exemplary and that the sub-structures 17 may have different shapes for providing periodic three-dimensional features 17c facing the elevator car 6 and the optical sensor 25.

For example, the sub-structures 17 may have a triangular shape including a horizontally extending side at the bottom and an inclined side at the top.

The optical sensor 25 comprises at least one light source 27, e.g. a laser light source 27, which is configured for emitting a light beam 30 towards the hoistway wall 15. The emitted light beam 30 may comprise visible light, IR light and/or UV light.

In case the elevator car 6 is located adjacent to one of the marking elements 13, the emitted light beam 30 is reflected by one of the plurality of sub-structures 17 and the reflected light 32 is detected by a light sensor 29 of the light sensor 29. The distance D between the optical sensor 25 and the hoistway wall 15 in the horizontal direction may extend up to 150 mm. The distance D in particular may be in the range of 50 mm to 150 mm (50 mm<D<150 mm), more particularly in the range of 75 mm to 100 mm (75 mm<D<100 mm).

The relation between the sub-structures 17 of a three-dimensional structure 12 and the signal 34 provided by the light sensor 29 is illustrated in FIG. 4.

Due to the periodicity of the three-dimensional structure 12, the signal 34 provided by the light sensor 29 oscillates when the elevator car 6 travels along the hoistway 4 passing the three-dimensional structure 12.

Thus, the position of the elevator car 6 along the hoistway 4 may be determined by counting the peaks 36 of the signal 34 provided by the light sensor 29 while the elevator car 6 travels along the hoistway 4. For clarity, only some peaks 36 and the sub-structures 17 of the three-dimensional structure 12 are provided with reference signs in FIG. 4.

Counting the peaks 36 of the signal 34 provided by the light sensor 29 allows determining the current position of the elevator car 6 within the hoistway 4 with good accuracy in the sections of the hoistway 4 which are provided with the three-dimensional structure 12. The achievable accuracy is set by the dimension of the sub-structures 17 and the time resolution of the optical sensor 25.

The optical sensor 25 in particular may be capable of counting 500 features (edges) 17c per second. In the door zones close to the landings, the optical sensor 25 may provide pulses having a length between 0.5 ms and 500 ms, respectively.

By providing three-dimensional structures 12 in the areas adjacent to the landings 8, the elevator car 6 may be positioned at a desired landing 8 with good accuracy preventing the formation of a noticeable step between the desired landing 8 and the floor 16 of the elevator car 6.

In particular, the speed of the elevator car 6 approaching a desired landing 8 may be reduced when the elevator car 6 is determined to be located within a predetermined first distance d₁ from the desired landing 8, and the movement of the elevator car 6 may be stopped as soon as the elevator car 6 is determined to be located within a predetermined second distance d₂, which is smaller than the predetermined first distance d₁ (d₂<d₁), from the desired landing 8 (see FIG. 1).

An optical sensor 25 in combination with at least one three-dimensional structure 12 according to exemplary embodiments of the invention also may be used for re-leveling an elevator car 6 positioned at a landing 8.

While the elevator car is positioned at a landing 8, the actual position of the elevator car 6 may be continuously monitored employing the optical sensor 25. When the position of the elevator car 6 along the height of the hoistway 4 changes for more than a predetermined third distance d₃ (see FIG. 1), e.g. due to a change of weight of the elevator car 6 caused by passengers leaving or entering the elevator car 6, the elevator car 6 may be re-leveled, i.e. the position of the elevator car 6 within the hoistway 4 may be adjusted by appropriately controlling the drive unit 5 in order to prevent the formation or increase of a step between the desired landing 8 and the floor 16 of the elevator car 6.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention not be limited to the particular embodiments disclosed, but that the invention include all embodiments falling within the scope of the claims.

### REFERENCES

2 elevator system
3 tension member
4 hoistway
5 drive
6 elevator car
7a landing control panel
7b car operation panel
8 landing
9 landing door frame
10 landing door
11 elevator car door
12 three-dimensional structure
13 marking element
14 sections of the hoistway wall not provided with a 3D-structure
15 hoistway wall
16 floor of the elevator car
17 sub-structure
17a upper side
17b lower side
17c periodic three-dimensional feature/edge
18 elevator control unit
23 signal line
25 optical sensor
26 speed and/or acceleration sensor
27 light source
28 light sensor
30 emitted light beam
32 reflected light beam
34 signal provided by the light sensor
36 peaks of the signal provided by the light sensor
H height of the sub-structure
L length of the sub-structure
D distance between the hoistway wall and the elevator car
d₁ first predetermined distance
d₂ second predetermined distance
d₃ third predetermined distance

What is claimed is:

1. Elevator system (2) comprising
a hoistway (4) extending in a longitudinal direction between a plurality of landings (8);
an elevator car (6) configured for traveling along the hoistway (4) between the plurality of landings (8);
at least one three-dimensional structure (12) extending in a longitudinal direction along at least a section of the hoistway (4);
an optical sensor (25) attached to the elevator car (6) and configured for detecting the at least one three-dimensional structure (12) for determining the current position of the elevator car (6) within the hoistway (4).

2. Elevator system (2) according to claim 1, wherein the at least one three-dimensional structure (12) is periodic in the longitudinal direction and wherein the optical sensor (25) is configured for detecting and counting periodic three-dimensional features (17c) of the at least one three-dimensional structure (12) passed by the elevator car (6) when moving along the hoistway (4).

3. Elevator system (2) according to claim 1, wherein the periodic three-dimensional features (17c) of the at least one three-dimensional structure (12) include edges (17c).

4. Elevator system (2) according to claim 1, wherein the at least one three-dimensional structure (12) comprises a plurality of sub-structures (17), in particular sub-structures (17) having a triangular cross-section.

5. Elevator system (2) according to claim 1, wherein the optical sensor (25) is mounted on top, at a side or at the bottom of the elevator car (6).

6. Elevator system (2) according to claim 1, comprising a three-dimensional structure (12) extending over the whole height of the hoistway (4).

7. Elevator system (2) according to claim 1, comprising a plurality of three-dimensional structures (12), each three-dimensional structure (12) extending over a section of the height of the hoistway (4), in particular over a section of the hoistway (4) adjacent to one of the landings (8).

8. Elevator system (2) according to claim 1, wherein the at least one three-dimensional structure (12) is provided by at least one marking element (13) mounted to a wall of the hoistway (4).

9. Elevator system (2) according to claim 1, wherein the at least one three-dimensional structure (12) is provided by at least one marking element (13) mounted to at least one door frame (9) of a landing door (10) at one of the landings (8).

10. Elevator system (2) according to claim 1, wherein the optical sensor (25) comprises at least one light source (27) configured for emitting and detecting visual light.

11. Elevator system (2) according to claim 1, wherein the optical sensor (25) comprises at least one light source (27) configured for emitting and detecting IR and/or UV light.

12. Elevator system (2) according to claim 1, wherein the optical sensor (25) comprises a laser light source (27).

13. Method of determining the position of an elevator car (6) in the hoistway (4) of an elevator system (2) according to claim 1, wherein the method includes moving the elevator car (6) along the hoistway (4), detecting the at least one three-dimensional structure (12) and determining the current position of the elevator car (6) within the hoistway (4), in particular by counting periodic three-dimensional features (17c) of the at least one three-dimensional structure (12) passed by the elevator car (6).

14. Method of operating an elevator system (2) according to claim 13, wherein the method includes reducing the speed of the elevator car (6) when the determined position of the elevator car (6) is within a given first distance (d₁) around a predetermined destination landing (8), and stopping the elevator car (6) when the determined position of the elevator car (6) is within a given second distance (d₂) around the predetermined destination landing (8).

15. Method of operating an elevator system (2) according to claim 13, wherein the method includes stopping the elevator car (6) at a landing (8), determining any movement of the elevator car (6) by detecting the at least one three-dimensional structure (12), and changing the position of the elevator car (6) in case the difference between the determined position of the elevator car (6) and a predetermined position associated with the landing (8) exceeds a given threshold (d₃).
